(19) United States
(12) Patent Application Publication
(10) Pub. No.: US 2009/0042015 A1
(43) Pub. Date: Feb. 12, 2009

(54) WHITE, POROUS, SINGLE-LAYER POLYESTER FILM AND METHOD FOR PREPARING SAME

(75) Inventors: Jae Seog Ju, Gyeonggi-do (KR); Young Ki Chun, Gyeonggi-do (KR); Yun Su Kim, Gyeonggi-do (KR); Hye Young Bae, Gyeonggi-do (KR)

Correspondence Address: Baker & Hostetler LLP;Attn: Jim Coffman, 45 Rockefeller Plaza, New York, NY, 10111, US

(73) Assignee: SKC CO., LTD., Kyungki-do (KR)

(21) Appl. No.: 12/094,217

(22) PCT Filed: Nov. 20, 2006
(86) PCT No.: PCT/KR2006/004878

§ 371 Date: Sep. 15, 2008

(30) Foreign Application Priority Data
Nov. 18, 2005 (KR) 10-2005-0110618

(51) Int. Cl. B32B 3/26; B29C 55/12

(52) U.S. Cl. 428/317.9; 428/304.4; 264/210.7

(57) ABSTRACT

The present invention relates to a white, porous, single-layer polyester film comprising a polyester resin, particles of a noncrystalline polymer which has a heat deformation temperature higher than the temperature of the drawing process of said film by at least 10° C. and is not miscible with the polyester resin, inorganic particles and a whitening agent. The inventive single layer film has sufficient process stability as well as good optical properties, and thus is useful as a film for use in printing, labeling, electronics and display applications.

### FIELD OF THE INVENTION

The present invention relates to a white, porous polyester film having single layered structure.

### BACKGROUND OF THE INVENTION

White, porous polyester films have been used in printing, labeling, electronics and display applications, because of their excellent whiteness, reflectance and masking properties. Such a polyester film has been generally prepared by incorporating an organic or inorganic additive for forming voids. For example, JP Application Laid-Open No. S58-50625 suggests the use of a foaming agent for generating voids, and JP Application Laid-Open No. S57-49648, the use of a polyolefin resin. However, the polyolefin resin is not miscible with a polyester resin and uniform pore-formation cannot be achieved, which leads to film breakage during the step of preparing the film.

In order to overcome such problems, JP Application Laid-Open No. P3-20328 and Korean Patent No. 10-0215496 provide a white polyester laminated film comprising (A) a polyester resin layer containing a mixture of inorganic particles having an average size of 0.5˜2 μm and inorganic particles having an average size of 2˜10 μm, and (B) one or two polyolefin (e.g., polymethylpentene) layers containing fine voids which are laminated on one or both surface of the polyester resin layer. Such laminated films are commercially available as trade names E60L, E6SL and E6SV (Toray Industries, Inc.).

However, the above mentioned multi-layered (A/B or A/B/A) film must be prepared using a complex co-extruding procedure and this preparation method is not suitable for using waste chips recovered from the film-making process.

### SUMMARY OF THE INVENTION

Accordingly, it is an object of the present invention to provide a white, porous polyester film in the form of a single layer structure, which has satisfactory properties and can be prepared in an economic way using reclaimed chips.

In accordance with an aspect of the present invention, there is provided a white, porous, single-layer polyester film comprising a polyester resin, particles of a noncrystalline polymer which has a heat deformation temperature higher than the temperature of the drawing process of said film by at least 10° C. and is not miscible with the polyester resin, inorganic particles and a whitening agent.

In accordance with another aspect of the present invention, there is provided a method for preparing a white, porous, single-layer polyester film comprising blending a polyester resin, particles of a noncrystalline polymer which has a heat deformation temperature higher than the temperature of the drawing process of said film by at least 10° C. and is not miscible with the polyester resin, inorganic particles and a whitening agent; melt-extruding the blended resin to obtain a film sheet; and biaxially drawing the sheet.

### DETAILED DESCRIPTION OF THE INVENTION

The white porous polyester film according to the present invention consists of a single layer comprising a polyester resin; a noncrystalline polymer which is immiscible with the polyester and has a heat deformation temperature high enough to impart superior process stability to the film; inorganic particles; and a whitening agent.

The inventive polyester film has good optical properties such as a whiteness index of 99.5 or higher, a light transmittance of 3% or less, an average reflectance of 95% or higher at a wavelength of 450 to 700 nm and a reflectance 96% or higher at wavelength of 550 nm.

The polyester resin which may be used in the present invention includes polyethylene terephthalate (PET), polyethylene naphthalate (PEN) and a mixture thereof, which may be prepared by polycondensing an acid component comprising an aromatic dicarboxylic acid with a glycol component comprising an alkylene glycol. Examples of the aromatic dicarboxylic acid include dimethyl terephthalic acid, terephthalic acid, isophthalic acid, dimethyl-2,5-naphthalene dicarboxylic acid, naphthalene dicarboxylic acid, cyclohexane dicarboxylic acid, diphenoxyethane dicarboxylic acid, diphenyl dicarboxylic acid, diphenylether dicarboxylic acid, anthracene dicarboxylic acid, α,β-bis(2-chlorophenoxy) ethane-4,4-dicarboxylic acid and a mixture thereof. Examples of the alkylene glycol include ethylene glycol, trimethylene glycol, tetramethylene glycol, pentamethylene glycol, hexamethylene glycol, hexylene glycol and a mixture thereof.

In the present invention, the inorganic particles are used to control the optical properties of the film such as light transmittance, reflectance and color tone, as well as other properties such as frictional coefficient and surface roughness, and they are added to the polyester resin by way of compounding. Examples of the inorganic particles include particles of titanium dioxide, barium sulfate, calcium carbonate, silica, kaoline, talc, zeolite and a mixture thereof.

It is desired that the inorganic particles have an average particle diameter of 0.1 to 0.7 μm, preferably 0.2 to 0.35 μm to obtain the desired optical and surface properties of the film. When the diameter is larger than 0.7 μm, the drawing of the film becomes difficult. For example, if inorganic particles of 0.5˜2 μm and inorganic particles of 2˜10 μm are used as disclosed in Korean Patent No. 10-0215496, the film tend to break easily during drawing.

The inventive polyester film also comprises noncrystalline polymer particles immiscible with the polyester resin, which facilitates void formation together with the inorganic particles. The noncrystalline polymer preferably has a heat deformation temperature higher than the drawing temperature of the film by at least 10° C.

The noncrystalline polymer used in the present invention is more preferably a cyclic olefin copolymer having a glass transition temperature (Tg) of 140° C. or higher, even more preferably a norbonene-ethylene copolymer, most preferred is norbonene-ethylene copolymer having an average particle diameter of 0.2to 10 μm.

The noncrystalline polymer particles and the inorganic particles may be used separately, or the inorganic particles coated with the noncrystalline polymer particles may be used.

The noncrystalline polymer particles and the inorganic particles may be used in an amount of 5 to 15 wt % based on the total weight of the film, respectively. Also, it is desired that the combined amount of the noncrystalline polymer and inorganic particles used is 10 to 30 wt %, preferably 15 to 25 wt % based on the total weight of the film.

The inventive polyester film further comprises a whitening agent to enhance the whiteness and reflectance of the film. The reflectance of the film may be measured using L* and b* values of CIELAB system. If the L* value is less than 95.00, the reflectance of the film becomes unsatisfactory. If the b* value is more than −3, the film's appearance becomes yellow and the reflectance deteriorates. Accordingly, in order to enhance the reflectance of the film at a wavelength of 420˜470 nm by increasing the L* value and decreasing the b* value of CIELAB system, the whitening agent is preferably used in an amount of 0.01 to 0.2 wt %, more preferably 0.05 to 0.15 wt % based on the total weight of the film. As the whitening agent, 2,2′-(1,2-ethendiyl-4,1-phenylene)bisbenzoxazole or 2,2-(4,4-diphenol vinyl)dibenzoxazole are preferred.

If necessary, the white porous polyester film according to the present invention may further comprise other components such as a polycondensation catalyst, dispersant, electrostatic generator, crystallization accelerator, antiblocking agent and inorganic lubricant.

The white porous polyester film according to the present invention may be prepared in the form of a singly layer by blending a polyester resin, particles of a noncrystalline polymer which has a heat deformation temperature higher than the drawing temperature of the film by at least 10° C. and is immiscible with the polyester resin, inorganic particles and a whitening agent; melt-extruding the blended resin to obtain a film sheet; and biaxially drawing the sheet in the longitudinal and transverse directions, for example, at a draw ratio of 3 to 6, preferably 3.0 to 4.5, respectively. Also, the inventive single layered film can be prepared by blending film chips obtained from said preparation procedure with reclaimed chips.

The noncrystalline polymer and the inorganic particles may be separately blended with the polyester resin. Alternatively, the inorganic particles may be first coated with the noncrystalline polymer in a biaxial kneader to form a chip, and then the kneaded chip may be added to the polyester resin.

In the present invention, the biaxially drawing procedure is preferably conducted in multi steps, at least two in both the longitudinal and transverse directions, to increase the efficiency of void formation without film breakage. For example, the first drawing step in either direction is conducted at a temperature higher than Tg of the polyester resin by 10 to 30° C. at a draw ratio of at least 1.5, before the second drawing step.

The polyester film thus prepared has a density of 0.8 to 1.2 g/cm³ and preferably a thickness of 50 to 250 μm.

The white porous polyester film having a single layer structure of the present invention has sufficient process stability as well as good optical properties such as whiteness, reflectance and masking property, and thus it is useful as a film for use in printing, labeling, electronics and display applications.

The present invention is further described and illustrated in Examples, which are, however, not intended to limit the scope of the present invention.

### EXAMPLE 1

Dimethyl terephthalate was mixed with ethylene glycol in an equivalent ratio of 1:2, to which 0.03 wt % of manganese acetate (a transesterification catalyst) was added to obtain bis-2-hydroxyethyl terephthalate as a terephthalate monomer. Thereto, 0.2 wt % of tetrakis-3,5-di-tert-butylhydroxyphenyl propanoylmethylmethane and 0.05 wt % of antimony oxide (a polymerization catalyst) were added, and the resulting mixture was polycondensed to obtain a polyester resin (Tg 73° C.) having an intrinsic viscosity of 0.61 dl/g.

The polyester resin thus obtained was supplied in a biaxial extruder, to which titanium dioxide having an average particle diameter of 0.25 μm (inorganic particles), norbornene-ethylene copolymer particles having a heat deformation temperature of 138° C. and an average particle diameter of 5 μm (Topas COC) (polymer particles) and a whitening agent were added in amounts of 10, 10 and 0.1 wt %, respectively, based on the total mixture, and the mixture was dried and melt-extruded. The extruded sheet was drawn in the longitudinal direction in two steps at a draw ratio of 1.5 and 2.5 at 85° C., and then in the transverse direction in two steps at a draw ratio of 1.5 at 100° C. and 2.5 at 125° C., to obtain a biaxially drawn, single-layered polyester film of 188 μm thickness.

### EXAMPLE 2

The procedure of Example 1 was repeated except that the inorganic particles and the norbornene-ethylene copolymer particles were mixed at a weight ratio of 1:1 in a super-mixer, the mixture was supplied to a biaxial kneader to coat the inorganic particles with the copolymer, and a mixture of 15 parts by weight of the resulting coated particles and 85 parts by weight of the polyester resin was melt-extruded, to obtain a biaxially drawn, single-layered polyester film.

### EXAMPLE 3

The procedure of Example 1 was repeated except that the norbornene-ethylene copolymer and the titanium dioxide were used in amounts of 13 wt % and 12 wt %, respectively, to obtain a biaxially drawn, single-layered polyester film.

### EXAMPLE 4

The procedure of Example 1 was repeated except that the second drawing step was conducted at a draw ratio of 3.0 in both the longitudinal and transverse directions, to obtain a biaxially drawn, single-layered polyester film.

### EXAMPLE 5

The procedure of Example 1 was repeated except that barium sulfate having an average particle diameter of 0.7 μm was used instead of titanium dioxide as inorganic particles, to obtain a biaxially drawn, single-layered polyester film.

### EXAMPLE 6

70 parts by weight of the film chips obtained in Example 1 were mixed with 30 parts by weight of reclaimed chips obtained by recovering the waste film generated during the procedure of Example 1, and then the resulting mixture was subjected to the melt-extruding and drawing procedure of Example 1, to obtain a biaxially drawn, single-layered polyester film.

### COMPARATIVE EXAMPLE 1

The procedure of Example 1 was repeated except that a crystalline homo polypropylene which is immiscible with the polyester resin, having a melting index of 10 g/min, Tg of −15° C. and a heat deformation temperature of 106° C., was used instead of the norbornene-ethylene copolymer, to obtain a biaxially drawn, single-layered polyester film.

### COMPARATIVE EXAMPLE 2

The procedure of Comparative Example 1 was repeated except that the homo polypropylene and the inorganic particles in an amount of 15 wt % were used, respectively, to obtain a biaxially drawn, single-layered polyester film.

### COMPARATIVE EXAMPLE 3

The procedure of Example 1 was repeated except that polymethylpentene immiscible with the polyester resin, having a thermal transition temperature of 100° C., was used instead of the norbornene-ethylene copolymer, to obtain a biaxially drawn, single-layered polyester film.

### COMPARATIVE EXAMPLE 4

Laminated to both surfaces of a resin layer comprising 10 wt % of polymethylpentene and 10 wt % of titanium dioxide were two polyester resin layers having no additives in a thickness ratio of 1:8:1 through co-extruding, and the resulting laminate was subjected to the drawing procedure of Example 1, to obtain a biaxially drawn, three-layered polyester film.

The polyester films manufactured in Examples 1 to 6 and Comparative Examples 1 to 4 were evaluated for the following properties, and the results are listed in Table 1.

### (1) Average Particle Diameter of Inorganic Particles:

Inorganic particles were dispersed in ethylene glycol and their particle size distribution was determined using a centrifugal particle size analyzer manufactured by Shimadzu, to determined their volume average particle diameter.

### (2) Apparent Density

The apparent density of a film was measured using a density-gradient tube comprising carbon tetrachloride and n-hepthane at 25° C. by a floation method.

### (3) Whiteness

The whiteness of a film was measured in accordance with the ASTM E313 using a spectro-photometer (Minolta, Japan).

(4) Reflectance (L* and b* of CIELAB system)

The reflectance of a film was measured using a spectro-photometer (Minolta, Japan).

### (5) Process Stability

The process stability of a film was determined by measuring the frequency of film breakage during 12 hours in the process of preparing the film.

(6) Anti-aging property

The anti-aging property of a film was determined by measuring the color difference after being exposed under a UV lamp at 140° C. for 48 hours.

(7) Light transmittance

The light transmittance of a film was measured in accordance with the ASTM D1003 method.

TABLE 1

| | | | | | | | | | The properties of Biaxially drawn film | | | | | | |
|---|---|---|---|---|---|---|---|---|---|---|---|---|---|---|---|
| | | | | | | | | | | | | | | | Color |
| | | | | | | | | | | | | | Average | | Dif- |
| | Additives | | | | | Drawing Conditions | | | | | | | Reflec- | | ferance |
| | Inorganic | | | | | Final | | | Break- | | Light | | tance | Reflec- | After |
| | particles | | Polymer particles | | | Drawing | Draw Ratio | | age | | Trans- | White- | at 450~ | tance | Aging |
| Ex. | | Wt | | T_{HD}¹⁾ | Wt | Tem. | LD | TD | Freq./ | Density | mittance | ness | 700 nm | at 500 nm | (ΔE*ab) |
| No. | Type | % | Type | (° C.) | % | (° C.) | 1st/2nd | 1st/2nd | 14 hr | (g/cm³) | (%) | (%) | (%) | (%) | (%) |
| Ex. 1 | TiO₂ | 10 | N-E²⁾ | 138 | 10 | 125 | 1.5/2.5 | 1.5/2.5 | 0 | 1.05 | 3 | 99.7 | 96.0 | 97.0 | 2.5 |
| Ex. 2 | | 7.5 | | | 7.5 | | 1.5/2.5 | 1.5/2.5 | 0 | 1.05 | 3 | 99.7 | 95.9 | 96.9 | 2.2 |
| Ex. 3 | | 12 | | | 13 | | 1.5/2.5 | 1.5/2.5 | 1 | 1.00 | 2 | 99.9 | 96.5 | 97.8 | 2.1 |
| Ex. 4 | | 10 | | | 10 | | 1.5/3.0 | 1.5/3.0 | 2 | 1.00 | 2 | 99.8 | 96.5 | 97.5 | 2.4 |
| Ex. 5 | BaSO₄ | 10 | | | 10 | | 1.5/2.5 | 1.5/2.5 | 1 | 1.00 | 3 | 99.7 | 95.8 | 96.8 | 2.3 |
| Ex. 6 | TiO₂ | 10 | | | 10 | | 1.5/2.5 | 1.5/2.5 | 0 | 1.05 | 3 | 99.0 | 95.5 | 96.5 | 2.5 |
| Com. | TiO₂ | 10 | PP³⁾ | 106 | 10 | | 1.5/2.5 | 1.5/2.5 | 2 | 1.25 | 5 | 98.6 | 91.0 | 93.0 | 9.4 |
| Ex. 1 | | | | | | | | | | | | | | | |
| Com. | | 15 | | | 15 | | 1.5/2.5 | 1.5/2.5 | 7 | 1.15 | 4 | 99.0 | 94.2 | 95.5 | 10.5 |
| Ex. 2 | | | | | | | | | | | | | | | |
| Com. | | 10 | PMP⁴⁾ | 100 | 10 | | 1.5/2.5 | 1.5/2.5 | 5 | 1.05 | 3 | 98.8 | 94.6 | 95.6 | 4.9 |
| Ex. 3 | | | | | | | | | | | | | | | |
| Com. | | 10 | | | 10 | | 1.5/2.5 | 1.5/2.5 | 3 | 1.05 | 3 | 99.0 | 94.8 | 95.8 | 3.8 |
| Ex. 4 | | | | | | | | | | | | | | | |

¹⁾Heat deformation temperature
²⁾Norbonen-ethylene copolymer
³⁾Homo polypropylene
⁴⁾Polymethylpentene

As shown in Table 1, the single-layered films of Examples 1 to 6 according to the present invention showed little film breakage, a whiteness index of 99.5 or higher, light transmittance of 3% or less, an average reflectance of 95% or higher at a wavelength of 450 to 700 nm, a reflectance 96% or higher at wavelength of 550 nm and a color difference after aging of 2.5% or less, while the films of Comparative Examples 1 to 4 showed inferior results than the inventive films for said properties.

Thus, the inventive films are much more preferred than conventional films represented by Comparative Examples 1 to 4 for use in printing, labeling, electronics and display applications.

While the invention has been described with respect to the above specific embodiments, it should be recognized that various modifications and changes may be made to the invention by those skilled in the art which also fall within the scope of the invention as defined by the appended claims.

What is claimed is:

1. A white, porous, single-layer polyester film comprising a polyester resin, particles of a noncrystalline polymer which has a heat deformation temperature higher than the temperature of the drawing process of said film by at least 10° C. and is not miscible with the polyester resin, inorganic particles and a whitening agent.

2. The single-layer polyester film of claim 1, wherein the noncrystalline polymer is a cyclic olefin copolymer having a glass transition temperature (Tg) of 140° C. or higher.

3. The single-layer polyester film of claim 2, wherein the noncrystalline polymer is a norbonene-ethylene copolymer.

4. The single-layer polyester film of claim 1, wherein the noncrystalline polymer particles, the inorganic particles and the whitening agent are used in amounts of 5 to 15 wt %, 5 to 15 wt %, and 0.01 to 0.2 wt %, respectively, based on the total weight of the film.

5. The single-layer polyester film of claim 1, wherein the polyester resin is polyethylene terephthalate (PET), polyethylene naphthalate (PEN) and a mixture thereof.

6. The single-layer polyester film of claim 1, wherein the inorganic particles is selected from the group consisting of particles of titanium dioxide, barium sulfate, calcium carbonate, silica, kaoline, talc, zeolite and a mixture thereof having an average particle diameter of 0.1 to 0.7 μm.

7. The single-layer polyester film of claim 1, wherein the inorganic particles are present in the form coated with the noncrystalline polymer.

8. The single-layer polyester film of claim 1, wherein the sum of the amounts of the noncrystalline polymer and the inorganic particles is 10 to 30 wt % based on the total weight of the film.

9. The single-layer polyester film of claim 1, wherein the whitening agent is 2,2′-(1,2-ethendiyl-4,1-phenylene)bisbenzoxazole or 2,2-(4,4-diphenol vinyl)dibenzoxazole.

10. A method for preparing a white, porous, single-layer polyester film comprising blending a polyester resin, particles of a noncrystalline polymer which has a heat deformation temperature higher than the temperature of the drawing process of said film by at least 10° C. and is not miscible with the polyester resin, inorganic particles and a whitening agent; melt-extruding the blended resin to obtain a film sheet; and biaxially drawing the sheet.

11. The method of claim 10, wherein the inorganic particles is coated with the noncrystalline polymer before being blended with the polyester resin.

12. The method of claim 10, wherein the biaxially drawing procedure is conducted by at least two drawing steps in both the longitudinal and transverse directions, the first drawing step in either direction being conducted at a temperature higher than Tg of the polyester resin by 10 to 30° C. at a draw ratio of at least 1.5.
